(19) United States
(12) Patent Application Publication
(10) Pub. No.: US 2026/0018831 A1
(43) Pub. Date: Jan. 15, 2026

(54) CONNECTOR

(71) Applicant: SUMITOMO WIRING SYSTEMS, LTD., Mie (JP)

(72) Inventor: Temma FUJIOKA, Mie (JP)

(21) Appl. No.: 19/264,045

(22) Filed: Jul. 9, 2025

(30) Foreign Application Priority Data
Jul. 11, 2024 (JP) 2024-111690

(51) Int. Cl. H01R 13/639; H01R 13/533; H01R 13/631

(52) U.S. Cl. CPC H01R 13/639; H01R 13/533; H01R 13/631; H01R 2201/26

(57) ABSTRACT

A connector includes a connector housing configured to be fitted to a counterpart housing by being moved relative to the counterpart housing in a fitting direction extending along a first axis. The connector housing includes a lock arm extending in a fitting-opposite direction, the lock arm includes a protrusion configured to flex the lock arm in a downward direction by being pressed by a counterpart engaging part while the connector housing is being fitted to the counterpart housing, the protrusion includes a protrusion-rear end face and at least one protruding portion protruding from the protrusion-rear end face, the protruding portion is disposed within a range of a movement trajectory of an apex of the protrusion during flexing of the lock arm.

### CROSS-REFERENCE TO RELATED APPLICATIONS

This application is based on and claims priority from Japanese Patent Application No. 2024-111690, filed on Jul. 11, 2024, with the Japan Patent Office, the disclosure of which is incorporated herein in its entirety by reference.

### TECHNICAL FIELD

The present disclosure relates to a connector.

### BACKGROUND

Conventionally, a connector including a resin connector housing that can be fitted to a counterpart housing in a fitting direction extending along a first axis, and a terminal configured to be mounted to the connector housing is available (see e.g., JP 2024-055303 A). The connector housing includes a lock arm extending in a direction opposite to the fitting direction, and the lock arm includes protrusions. The protrusions flex the lock arm in the downward direction by being pressed by a counterpart engaging part of the counterpart housing while the connector housing is being fitted to the counterpart housing. Then, once the counterpart engaging part has passed over the protrusions and the connector housing has been completely fitted to a counterpart connector, the lock arm that has been elastically deformed in the downward direction returns to its original position in the upward direction. Consequently, protrusion-rear end faces that are rear end faces of the protrusions in the fitting-opposite direction are opposed to the counterpart engaging part in the fitting direction, thereby preventing separation of the connector housing from the counterpart housing.

### SUMMARY

Meanwhile, in the connector as described above, a clearance is formed between the protrusions and the counterpart engaging part in a state in which the connector housing is fitted to the counterpart connector. This clearance is caused by movement of the protrusions due to flexural deformation of the lock arm. More specifically, when the lock arm is flexed in the downward direction, apexes, which are corners, of the protrusions move so as to rotate mainly about a base end portion of the lock arm. Accordingly, the apexes also move in the fitting-opposite direction while moving in the downward direction. Once the lock arm has returned to the original position in the upward direction, the apexes of the protrusions also move in the fitting direction. Accordingly, a clearance corresponding to the difference between these movements is formed. The clearance causes rattling between the counterpart housing and the connector housing along the first axis. Also, this rattling leads to, for example, deterioration in the communication performance of the terminal, and therefore it is desirable to reduce the rattling.

An object of the present disclosure is to provide a connector that can reduce the rattling between a counterpart housing and a connector housing along a first axis.

A connector according to the present disclosure is a connector including: a connector housing configured to be fitted to a counterpart housing by being moved relative to the counterpart housing in a fitting direction extending along a first axis; and a terminal accommodated inside the connector housing, wherein the connector housing includes a lock arm extending in a fitting-opposite direction that is opposite to the fitting direction, the lock arm includes a protrusion configured to flex the lock arm in a downward direction that is orthogonal to the fitting direction by being pressed by a counterpart engaging part of the counterpart housing while the connector housing is being fitted to the counterpart housing, the protrusion includes a protrusion-rear end face opposed to the counterpart engaging part in the fitting direction in a state in which the connector housing is fitted to the counterpart housing, and at least one protruding portion protruding in the fitting-opposite direction from the protrusion-rear end face, the protruding portion is disposed within a range of a movement trajectory of an apex of the protrusion during flexing of the lock arm, while including a protruding portion-rear end face opposed to the counterpart engaging part in the fitting direction in a state in which the connector housing is fitted to the counterpart housing, and the protruding portion-rear end face is shaped such that a component of a force received from the counterpart engaging part does not act in the downward direction.

With the connector according to the present disclosure, it is possible to reduce the rattling between a counterpart housing and a connector housing along a first axis.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE DRAWINGS

FIG. 1 is a perspective view of a connector and a counterpart connector according to an embodiment.

FIG. 2 is a partially exploded perspective view of the connector according to the embodiment.

FIG. 3 is a cross-sectional view of the connector and the counterpart connector according to the embodiment.

FIG. 4 is a partial plan view of the connector according to the embodiment.

FIG. 5 is a perspective view of a connector position assurance member according to the embodiment.

FIG. 6 is a cross-sectional view taken along the line 6-6 in FIG. 1.

FIG. 7 is a cross-sectional view taken along the line 7-7 in FIG. 1.

FIG. 8 is a partial cross-sectional view of the connector according to the embodiment.

FIG. 9 is a partial plan view of the connector and the counterpart connector according to the embodiment.

FIG. 10 is a cross-sectional view taken along the line 10-10 in FIG. 9.

FIG. 11 is a partial cross-sectional view of the connector and the counterpart connector according to the embodiment.

FIG. 12 is a cross-sectional view taken along the line 12-12 in FIG. 9.

FIG. 13 is a cross-sectional view of a connector and a counterpart connector according to a modification.

FIG. 14 is a cross-sectional view of a connector and a counterpart connector according to a modification.

FIG. 15 is a cross-sectional view of a connector and a counterpart connector according to a modification.

### DETAILED DESCRIPTION

In the following detailed description, reference is made to the accompanying drawings, which form a part hereof. The illustrative embodiments described in the detailed description, drawings, and claims are not meant to be limiting. Other embodiments may be utilized, and other changes may be made, without departing from the spirit or scope of the subject matter presented here.

### Description of Embodiments of the Present Disclosure

First, embodiments of the present disclosure will be listed and described.

[1] A connector according to the present disclosure is a connector including: a connector housing configured to be fitted to a counterpart housing by being moved relative to the counterpart housing in a fitting direction extending along a first axis; and a terminal accommodated inside the connector housing, wherein the connector housing includes a lock arm extending in a fitting-opposite direction that is opposite to the fitting direction, the lock arm includes a protrusion configured to flex the lock arm in a downward direction that is orthogonal to the fitting direction by being pressed by a counterpart engaging part of the counterpart housing while the connector housing is being fitted to the counterpart housing, the protrusion includes a protrusion-rear end face opposed to the counterpart engaging part in the fitting direction in a state in which the connector housing is fitted to the counterpart housing, and at least one protruding portion protruding in the fitting-opposite direction from the protrusion-rear end face, the protruding portion is disposed within a range of a movement trajectory of an apex of the protrusion during flexing of the lock arm, while including a protruding portion-rear end face opposed to the counterpart engaging part in the fitting direction in a state in which the connector housing is fitted to the counterpart housing, and the protruding portion-rear end face is shaped such that a component of a force received from the counterpart engaging part does not act in the downward direction.

With this configuration, the protrusion of the lock arm includes a protrusion-rear end face that is opposed to the counterpart engaging part and the fitting direction in a state in which the connector housing is fitted to the counterpart housing. Accordingly, separation of the connector housing from the counterpart housing is prevented. Also, the protrusion includes at least one protruding portion protruding in the fitting-opposite direction from the protrusion-rear end face, and the protruding portion includes a protruding portion-rear end face that is opposed to the counterpart engaging part in the fitting direction in a state in which the connector housing is fitted to the counterpart housing. Accordingly, the clearance can be smaller as compared with that of a configuration that does not include the protruding portion. That is, the rattling between the counterpart housing and the connector housing in the first axis can be reduced as compared with a configuration that does not include the protruding portion. The protruding portion is disposed within the range of the movement trajectory of the apex of the protrusion during flexing of the lock arm. Accordingly, the protruding portion will not collide with the counterpart engaging part when the lock arm that has been flexed in the downward direction during fitting of the connector housing to the counterpart housing returns to the original shape. Also, the protruding portion-rear end face is shaped such that a component of the force received from the counterpart engaging part does not act in the downward direction. Accordingly, for example, when a force acting in a direction in which the counterpart housing and the connector housing are separated from each other is applied, the lock arm will not be flexed in the downward direction. Thus, separation of the connector housing from the counterpart housing is prevented.

[2] In the above-described [1], the protruding portion-rear end face may have a planar shape that is orthogonal to the first axis.

With this configuration, the protruding portion-rear end face has a planar shape that is orthogonal to the first axis, and therefore it is possible, with a simple shape, to prevent a component of the force received from the counterpart engaging part from acting in the downward direction.

[3] In the above-described [1] or [2], an apex of the protruding portion may be located on the movement trajectory.

With this configuration, the apex of the protruding portion is located on the movement trajectory, and therefore it is possible to minimize the clearance for the height of the protruding portion-rear end face. That is, it is possible to minimize the rattling between the counterpart housing and the connector housing along the first axis for the height of the protruding portion-rear end face.

[4] In any one of the above-described [1] to [3], the terminal may be for use in high-speed communication.

With this configuration, the terminal is for use in high-speed communication, the communication performance of high-speed communication can be favorably maintained. That is, although the communication performance of the high-speed communication terminal for high-speed communication deteriorates as the rattling between the counterpart housing and the connector housing in the first axis increases, this deterioration can be kept small.

[5] In any one of the above-described [1] to [4], the lock arm may include a pair of arm parts extending in the fitting-opposite direction from opposite lateral sides of the protrusion, and an operation part that couples the two arm parts to each other, and the protruding portion may be provided on each of the arm parts.

With this configuration, the lock arm includes a pair of arm parts extending in the fitting-opposite direction from opposite lateral sides of the protrusion, and an operation part that couples the two arm parts to each other, the protrusion and the counterpart engaging part can be disengaged from each other by depressing the operation part. Accordingly, the connector housing can be separated from the counterpart housing by moving the connector housing in the fitting-opposite direction relative to the counterpart housing while depressing the operation part. Since the protruding portion is provided on each of the arm parts, it is possible to reinforce the arm parts on which the load tends to be focused during depression of the operation part.

[6] In the above-described [5], the connector may further include a connector position assurance member including an action protrusion configured to: be exposed in an upward direction between the protrusion and the operation part in a state in which the connector housing is not fitted to the counterpart housing; be allowed to move in the downward direction relative to the protrusion in a state in which the connector housing is fitted to the counterpart housing; and prevent the lock arm from being flexed in the downward direction in a state in which the action protrusion is disposed in the downward direction relative to the protrusion.

With this configuration, the connector further includes the connector position assurance member including an action protrusion configured to prevent the lock arm from being flexed in the downward direction in a state in which the action protrusion is disposed in the downward direction relative to the protrusion, the engagement between the protrusion and the counterpart engaging part can be firmly maintained. Accordingly, separation of the connector housing from the counterpart housing is strongly prevented. Here, the protruding portion is provided on each of the two arm parts extending in the fitting-opposite direction from opposite lateral sides of the protrusion, and therefore will not interfere with the action protrusion exposed in the upward direction between the protrusion and the operation part.

[7] In any one of the above-described [1] to [6], an upper surface of the protruding portion may include an upper surface-inclined portion that is inclined obliquely upward from the protruding portion-rear end face in the fitting direction.

With this configuration, the upper surface of the protruding portion includes an upper surface-inclined portion that is inclined obliquely upward from the protruding portion-rear end face in the fitting direction. Accordingly, it is possible to prevent the counterpart engaging part from being continuously riding on the upper surface of the protruding portion. That is, for example, even if the upper surface of the protruding portion enters the lower surface side of the counterpart engaging part as a result of the lock arm being flexed in the downward direction due to vibrations or the like, the inclination of the upper surface-inclined portion allows the protrusion and the counterpart engaging part to be guided to their original engaging position.

### Details of Embodiments of the Present Disclosure

Specific examples of the present disclosure will be described below with reference to the drawings. In the drawings, portions of configurations may be shown exaggerated or simplified for convenience of description. In addition, dimensional proportions of the portions may differ between the drawings. Being “orthogonal” as used herein includes not only being exactly orthogonal, but also being substantially orthogonal, as long as the operations and effects of the present embodiment can be achieved. A “tubular shape” as described herein includes not only a shape with a peripheral wall continuously formed around the entire circumference in a circumferential direction, but also a tubular shape formed by a combination of a plurality of components, and a tubular shape having a partially cut-out portion or the like in a circumferential direction thereof, such as a C-shape. The outer circumferential shape of the “tubular shape” includes, but is not limited to, a circular shape, an elliptic shape, and a polygonal shape having a pointed or round angle. The “tubular shape” is a shape having a through hole in a plan view, and includes shapes in which the outer circumferential shape and the inner circumferential shape of the through hole are the same, and shapes in which the outer circumferential shape and the inner circumferential shape of the through hole are different. The “tubular shape” includes shapes having a predetermined length extending in an axial direction in which a central axis passing through the center of the through hole extends, and there is no limitation with respect to the size of the length. The term “opposed” as used herein means that surfaces or members are located in front of each other, and includes not only a case where they are located fully in front of each other, but also a case where they are located partially in front of each other. The terms “first”, “second”, “third”, and the like are used to simply differentiate objects, and not to be construed as ranking objects. It should be noted that the present invention is not limited to these examples, and is intended to include all modifications which fall within the scope of the claims and the meaning and scope of equivalents thereof.

### Configuration of Connector 10

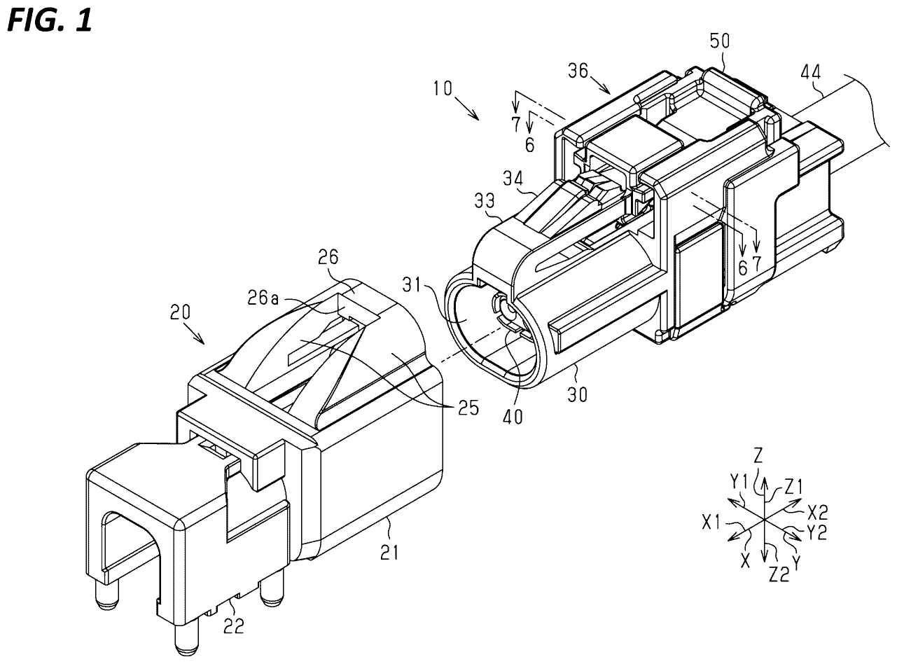

As shown in FIG. 1, a connector 10 is configured to be connected to a counterpart connector 20 by being moved relative thereto in a fitting direction X1 extending along a first axis X. The connector 10 and the counterpart connector 20 according to the present embodiment are provided in a vehicle. For example, the counterpart connector 20 is fixed to, for example, a case of an electrical device in the vehicle. For example, the connector 10 and the counterpart connector 20 according to the present embodiment are for use in high-speed communication applications.

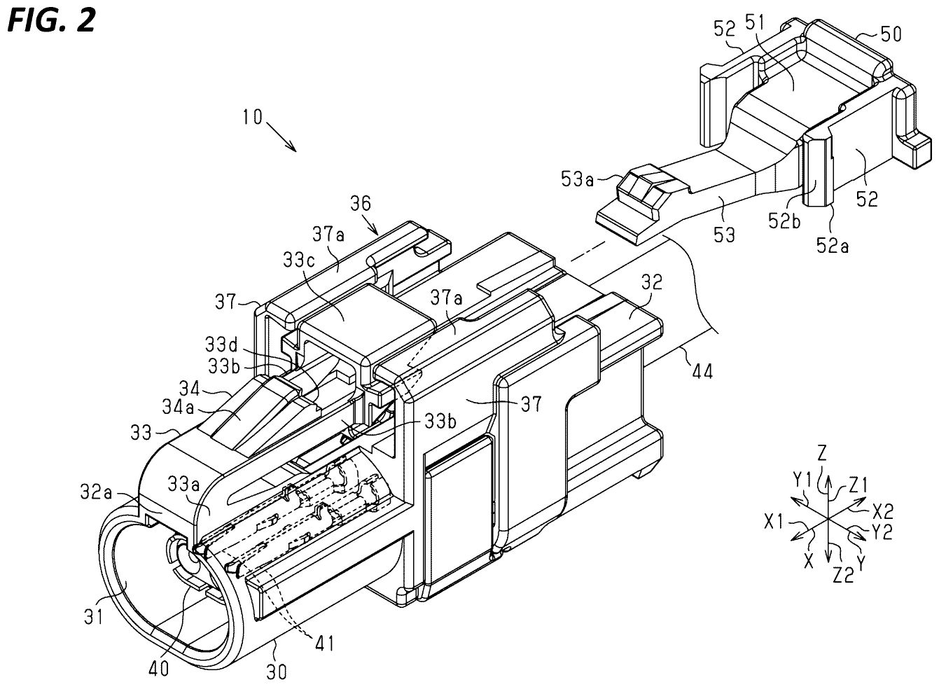

As shown in FIG. 2, the connector 10 includes a connector housing 30, a terminal unit 40, and a connector position assurance member 50.

Note that the first axis X, a second axis Y that is orthogonal to the first axis X, and a third axis Z that is orthogonal to the first axis X and is orthogonal to the second axis Y are illustrated in the drawings. A fitting direction X1 that is one direction extending along the first axis X, and a fitting-opposite direction X2 that is opposite to the fitting direction X1 are also illustrated in the drawings. A leftward direction Y1 that is one direction extending along the second axis Y, and a rightward direction Y2 that is opposite to the leftward direction Y1 are also illustrated in the drawings. An upward direction Z1 that is one direction extending along the third axis Z, and a downward direction Z2 that is a direction opposite to the upward direction Z1 are also illustrated in the drawings.

### Configuration of Counterpart Connector 20

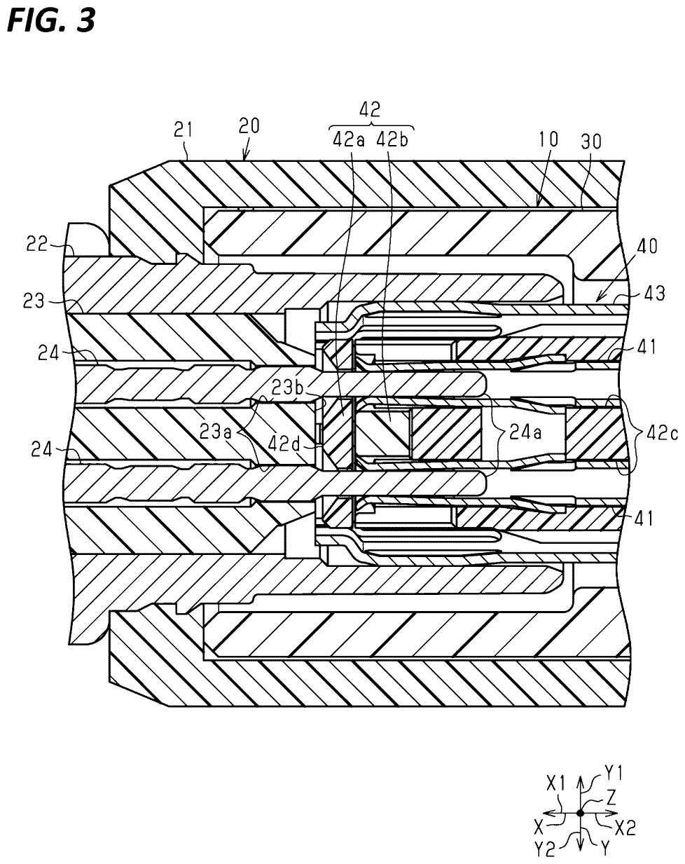

As shown in FIG. 1, the counterpart connector 20 includes a counterpart housing 21 and a counterpart sub-housing 22. In addition, as shown in FIG. 3, the counterpart connector 20 includes a counterpart dielectric 23 and at least one counterpart terminal 24. The counterpart connector 20 according to the present embodiment includes two counterpart terminals 24.

The counterpart housing 21 is made of a resin material.

As shown in FIG. 1, the counterpart housing 21 is formed in a tubular shape extending along the first axis X. The counterpart housing 21 includes a pair of counterpart support parts 25 extending in the upward direction Z1 from an upper surface of the counterpart housing 21, and a counterpart engaging part 26 that couples the two counterpart support parts 25 to each other. The counterpart engaging part 26 includes a locking surface 26a that is an end face located on the fitting direction X1 side.

The counterpart sub-housing 22 is made of a metal material. The counterpart sub-housing 22 is formed in a tubular shape extending along the first axis X. The fitting-opposite direction X2 side of the counterpart sub-housing 22 is inserted inside the counterpart housing 21.

The counterpart dielectric 23 shown in FIG. 3 is made of a resin material. The counterpart dielectric 23 is inserted inside the counterpart sub-housing 22. The counterpart dielectric 23 includes two counterpart holding holes 23a extending therethrough along the first axis X, and a counterpart opposed surface 23b that is an end face located on the fitting-opposite direction X2 side.

The counterpart terminals 24 are made of a metal material. The counterpart terminals 24 according to the present embodiment are rod-shaped male terminals extending along the first axis X. Each of the counterpart terminals 24 is accommodated and held by the corresponding counterpart holding hole 23a. A front end portion 24a of the counterpart terminal 24 protrudes from the counterpart opposed surface 23b.

### Configuration of Connector Housing 30

The connector housing 30 is made of a resin material.

As shown in FIG. 2, the connector housing 30 includes an accommodating hole 31 extending therethrough along the first axis X. In addition, the connector housing 30 includes a lock arm 33 extending in the fitting-opposite direction X2 from a front end portion 32a of the upper wall 32 in the fitting direction X1. The lock arm 33 is provided at a central portion of the connector housing 30 along the second axis Y. The lock arm 33 first protrudes from the upper wall 32 in the upward direction Z1, thereafter extends in the fitting-opposite direction X2, and is elastically deformable in the downward direction Z2.

The lock arm 33 includes a base end portion 33a, a protrusion 34, a pair of arm parts 33b, and an operation part 33c. The lock arm 33 is coupled to the upper wall 32 of the connector housing 30 at the base end portion 33a. The protrusion 34 is located at a central portion of the lock arm 33 along the first axis X, and protrudes in the upward direction Z1. The protrusion 34 includes an ascending inclined portion 34a that is inclined obliquely in the upward direction Z1 from the base end portion 33a in the fitting-opposite direction X2. The protrusion 34 has the function of flexing the lock arm 33 in the downward direction Z2 by being pressed by the counterpart engaging part 26 (see FIG. 1) that comes into sliding contact with the ascending inclined portion 34a while the connector housing 30 is being fitted to the counterpart housing 21. The two arm parts 33b extend in the fitting-opposite direction X2 from opposite lateral sides of the protrusion 34 in the second axis Y. The operation part 33c couples the two arm parts 33b to each other on the fitting-opposite direction X2 side. The lock arm 33 is elastically deformable in the downward direction Z2 by depressing the operation part 33c. The lock arm 33 includes a locking hole 33d extending therethrough in the third axis Z. The locking hole 33d is a hole surrounded by the protrusion 34, the two arm parts 33b, and the operation part 33c.

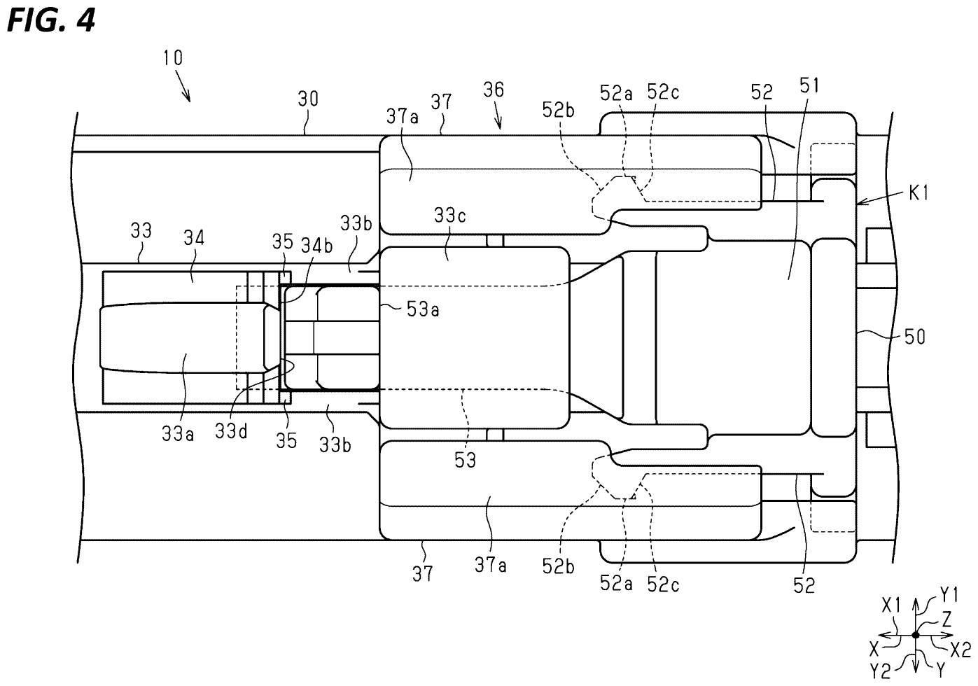

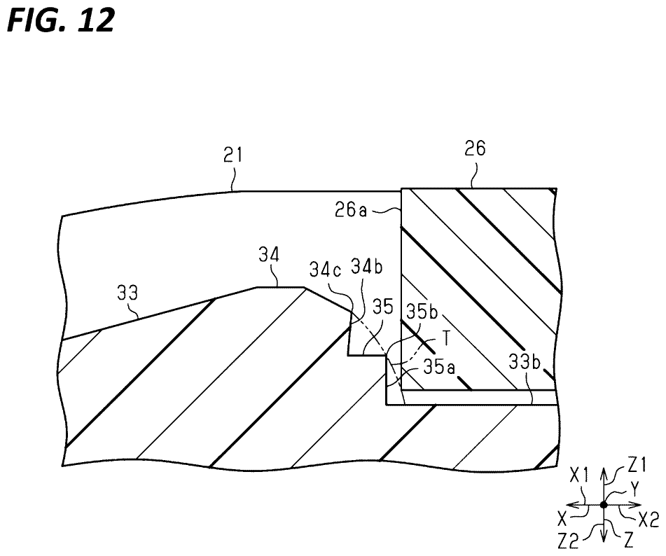

As shown in FIGS. 4 and 12, the protrusion 34 includes at least one protruding portion 35 protruding in the fitting-opposite direction X2 from a surface of the protrusion 34 that is located on the fitting-opposite direction X2 side, or in other words, a protrusion-rear end face 34b. The protruding portion 35 according to the present embodiment is provided on each of the two arm parts 33b. Specifically, two protruding portions 35 are provided, and each of the protruding portions 35 is provided so as to be coupled to an upper surface of the corresponding one of the two arm parts 33b.

As shown in FIG. 2, the connector housing 30 includes, on the upper wall 32, a mounting part 36 for the connector position assurance member 50. The mounting part 36 includes a pair of side walls 37 extending along the first axis X while protruding in the upward direction Z1, and arranged side by side along the second axis Y. The two side walls 37 are provided at positions of the lock arm 33 that sandwich the operation part 33c therebetween. The two side walls 37 include upper wall pieces 37a protruding in directions toward each other from upper ends thereof.

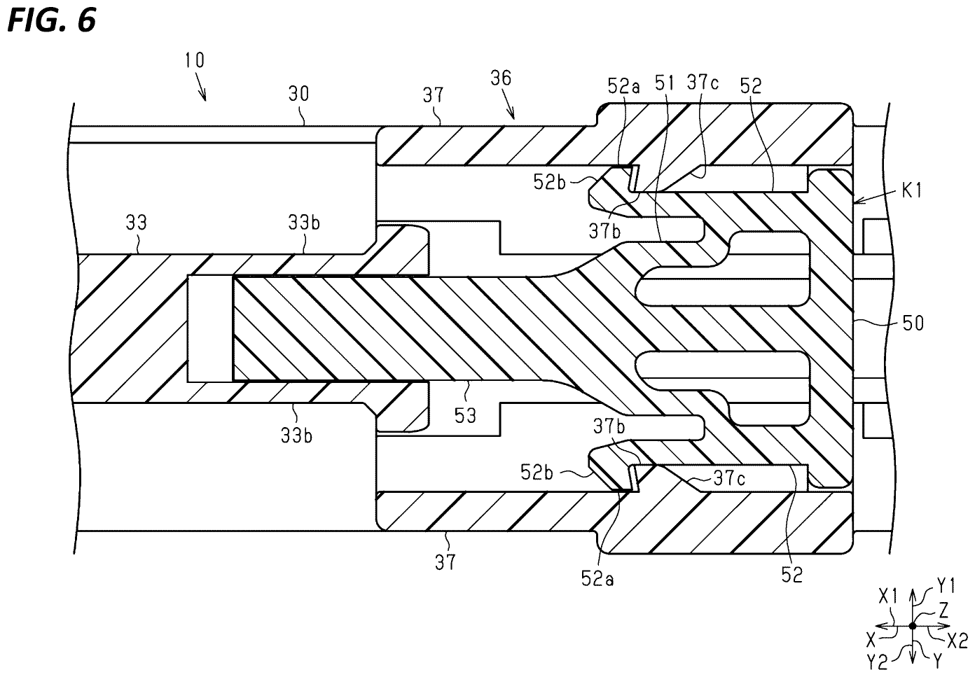

As shown in FIG. 6, the two side walls 37 include first projecting portions 37 protruding in directions toward each other from intermediate portions thereof extending along the first axis X. The fitting-opposite direction X2 side of the first projecting portions 37b is formed as an inclined portion 37c whose amount of protrusion from the corresponding side wall 37 gradually increases in the fitting direction X1.

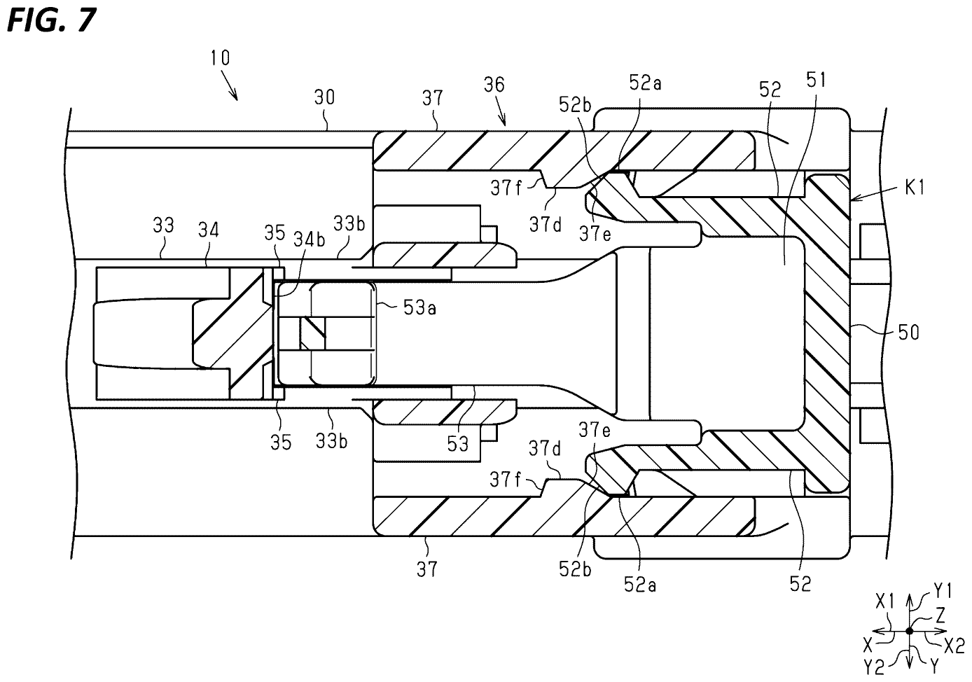

As shown in FIG. 7, the two side walls 37 include second projecting portions 37d protruding in directions toward each other from intermediate portions thereof along the first axis X. Each of the second projecting portions 37d is located in the fitting direction X1 and the upward direction Z1 relative to the corresponding first projecting portion 37b. The fitting-opposite direction X2 side of the second projecting portions 37d is formed as an inclined portion 37e whose amount of protrusion from the corresponding side wall 37 gradually increases in the fitting direction X1. The fitting direction X1 side of the second projecting portion 37d is formed as an inclined portion 37f whose amount of protrusion from the corresponding side wall 37 gradually increases in the fitting-opposite direction X2.

### Configuration of Terminal Unit 40

As shown in FIG. 3, the terminal unit 40 includes at least one terminal 41, a dielectric 42, and a shield member 43. The terminal unit 40 according to the present embodiment includes two terminals 41. The two terminals 41 are respectively connected to two core wires (not shown) accommodated inside a conductive member 44 (see FIG. 2).

The terminals 41 are made of a metal material. The terminals 41 according to the present embodiment are tubular female terminals extending along the first axis X. In addition, the terminals 41 are for use in high-speed communication. The dielectric 42 according to the present embodiment is formed by mounting an upper dielectric 42a and lower dielectric 42b to each other. The upper dielectric 42a and the lower dielectric 42b are made of a resin material. The dielectric 42 includes two holding holes 42c extending therethrough along the first axis X, and a dielectric-opposed surface 42d constituting an end face on the fitting direction X1 side. Also, the terminals 41 are accommodated and held in the holding holes 42c.

The shield member 43 is made of a metal material. The shield member 43 is formed in a tubular shape extending along the first axis X. The dielectric 42 is covered by the shield member 43 over the entire circumference thereof in the circumferential direction.

The terminal unit 40 is accommodated inside the connector housing 30. Specifically, the terminal unit 40 is held while being inserted into the accommodating hole 31 of the connector housing 30 in the fitting direction X1.

### Configuration of Connector Position Assurance Member 50

The connector position assurance member 50 is made of a resin material.

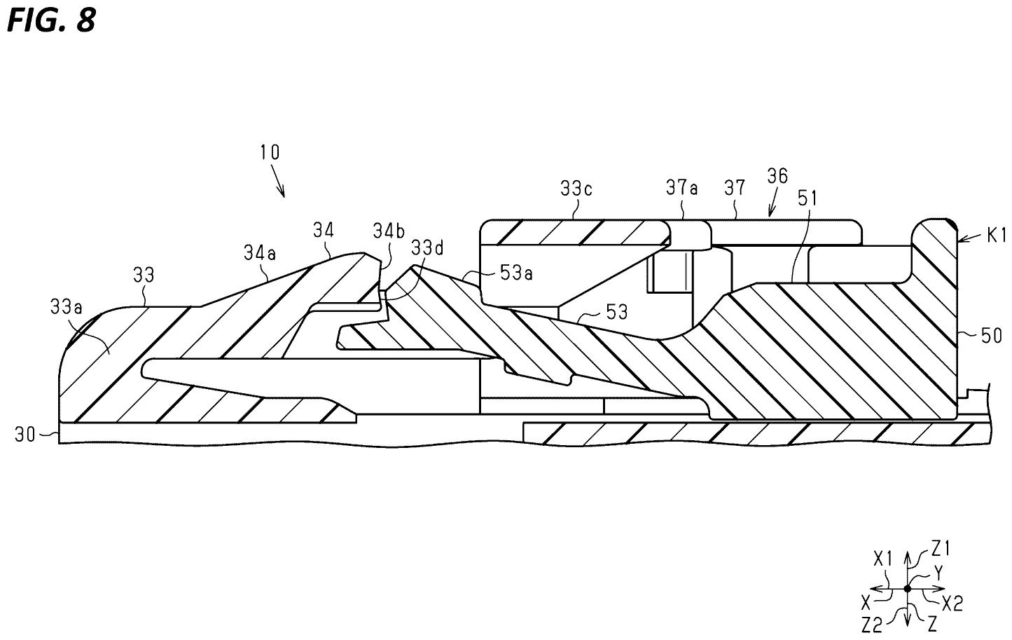

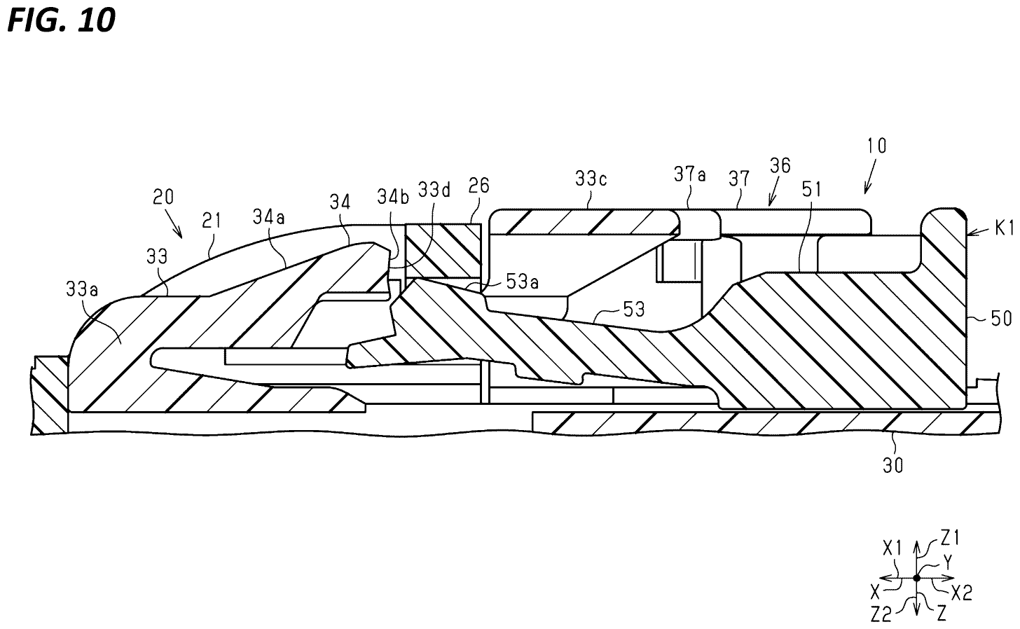

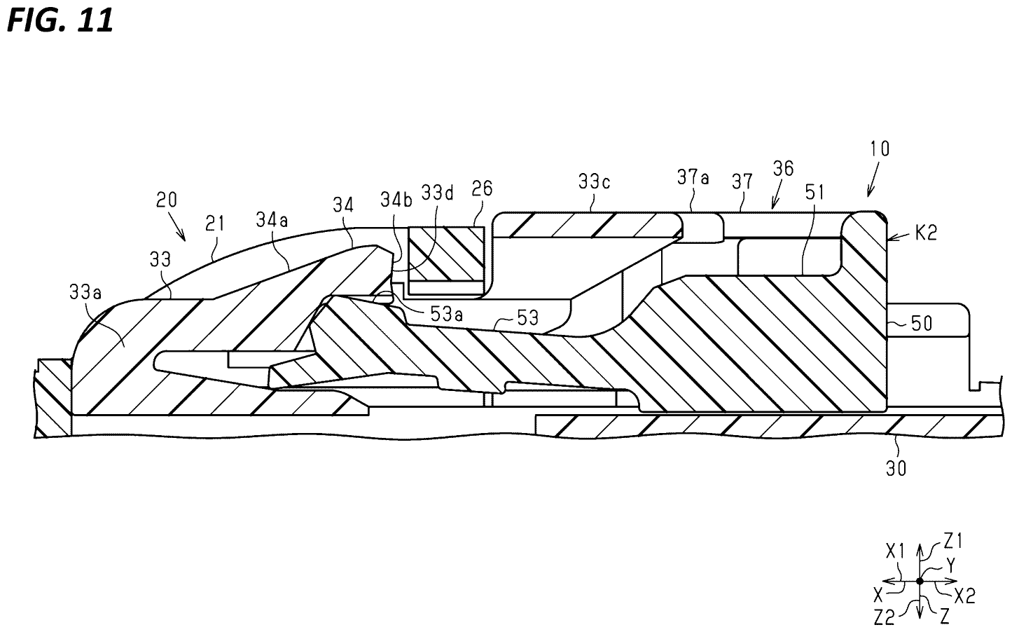

As shown in FIG. 4, the connector position assurance member 50 is mounted to the mounting part 36 of the connector housing 30. The connector position assurance member 50 is configured to be moved from a partial locking position K1 (see FIG. 8) toward a full locking position K2 (see FIG. 11) in a full locking direction X1 extending along the first axis X in a state in which the connector position assurance member 50 is mounted to the mounting part 36. Note that the full locking direction X1 according to the present embodiment is the same as the fitting direction X1. The connector position assurance member 50 is moved from the partial locking position K1 (see FIG. 10) to the full locking position K2 (see FIG. 11) in a state in which the connector housing 30 is fitted to the counterpart connector 20, thereby preventing separation of the connector housing 30 from the connector 20.

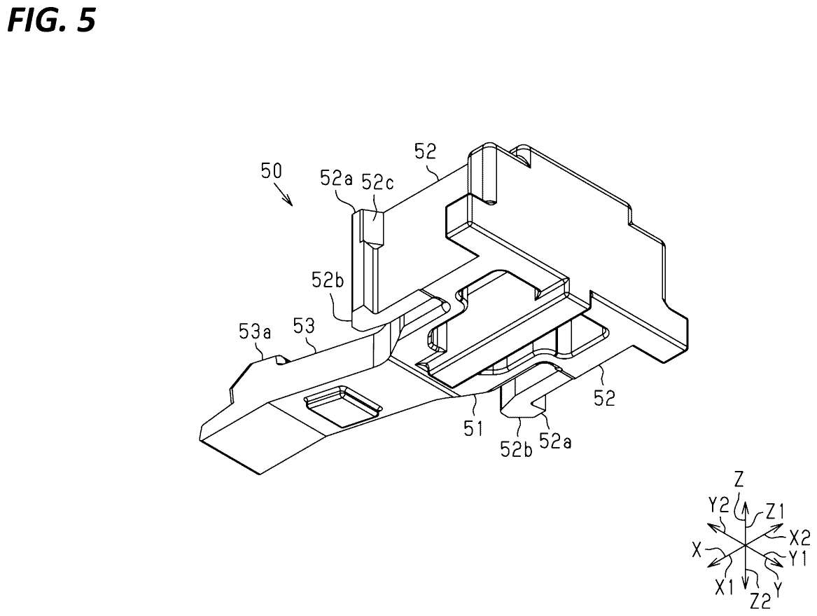

More specifically, as shown in FIGS. 2 and 5, the connector position assurance member 50 includes a body part 51, a pair of mounting pieces 52, and an action piece 53.

The two mounting pieces 52 are provided on opposite sides of the body part 51 and at opposite end portions along the second axis Y. The two mounting pieces 52 extend in the full locking direction X1, and are elastically deformable in directions toward each other and toward the body part 51. Front end portions of the two mounting pieces 52 respectively include mounting projecting portions 52a protruding in directions away from each other. Here, as shown in FIG. 2, the full locking direction X1 side of each of the mounting projecting portions 52a is formed as an inclined portion 52b whose amount of protrusion gradually increases in a direction away from the body part 51 in a full locking-opposite direction X2 that is opposite to the full locking direction X1. As shown in FIG. 5, the upward direction Z1 on the full locking-opposite direction X2 side of the mounting projecting portion 52a is formed as an inclined portion 52c whose amount of protrusion gradually increases in a direction away from the body part 51 in the full locking direction X1.

As shown in FIGS. 4, 6 and 7, the connector position assurance member 50 is mounted to the mounting part 36 of the connector housing 30 by being moved relative thereto in the full locking direction X1. Specifically, the connector position assurance member 50 is moved in the full locking direction X1 relative to the mounting part 36 so as to be disposed between the two side walls 37 in the downward direction Z2 relative to the upper wall pieces 37a (see FIG. 4) of the mounting part 36. At this time, the mounting projecting portions 52a ride over the first projecting portions 37b (see FIG. 6) of the two side walls 37 as a result of the two mounting pieces 52 being elastically deformed. At this time, since the mounting pieces 52 include the inclined portions 52b, and the first projecting portions 37b include the inclined portions 37c, the mounting projecting portions 52a can easily ride over the first projecting portions 37b of the side walls 37. Then, as shown in FIG. 6, the mounting projecting portions 52a are engaged with the first projecting portions 37b in the fitting-opposite direction X2, as a result of which the connector position assurance member 50 is prevented from coming off from the mounting part 36, and the connector position assurance member 50 is mounted to the mounting part 36. Note that the state shown in FIG. 6 in which the mounting projecting portions 52a are engaged with the first projecting portions 37b in the fitting-opposite direction X2 is a state in which the connector position assurance member 50 is at the partial locking position K1.

As shown in FIGS. 5 and 8, the action piece 53 extends from the body part 51 obliquely in the upward direction Z1 relative to the full locking direction X1, and is elastically deformable in the downward direction Z2. A front end portion of the action piece 53 includes an upwardly protruding action protrusion 53a. As shown in FIG. 8, the action protrusion 53a is formed so as to be exposed in the upward direction Z1 from the locking hole 33d of the lock arm 33 of the connector housing 30 in a state in which the connector position assurance member 50 is at the partial locking position K1. In addition, the action protrusion 53a is engaged with the protrusion-rear end face 34b in the full locking direction X1 in a state in which the connector position assurance member 50 is at the partial locking position K1, thereby preventing the connector position assurance member 50 from moving in the full locking direction X1, and hence toward the full locking position K2 (see FIG. 11).

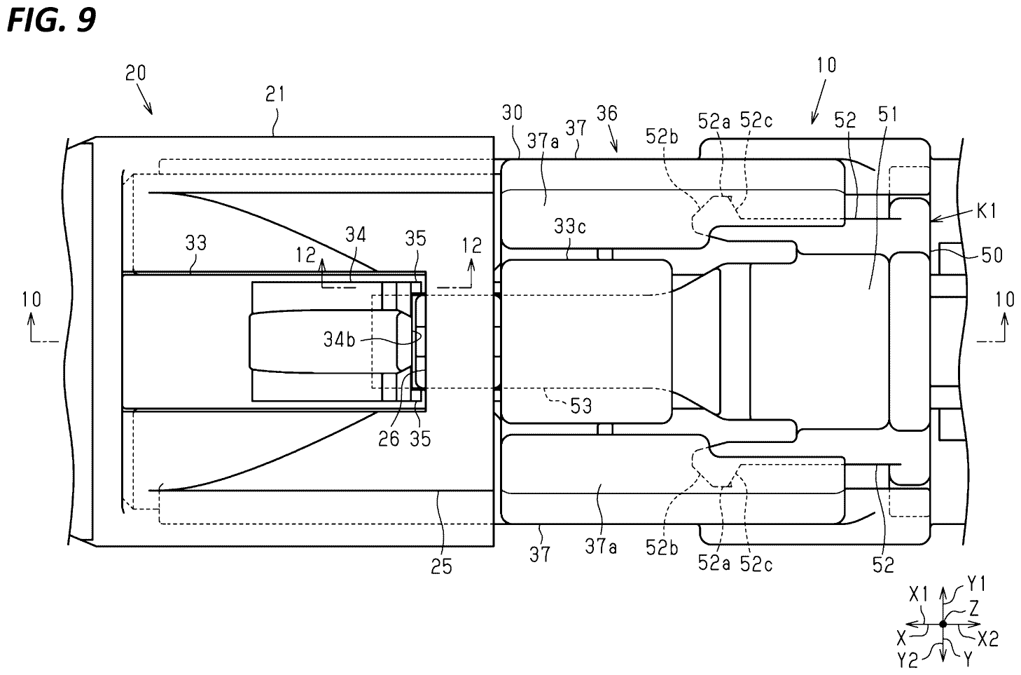

As shown in FIG. 10, once the connector housing 30 has been fitted to the counterpart housing 21, the action piece 53 is elastically deformed in the downward direction Z2. Specifically, as shown in FIGS. 1 and 10, the counterpart engaging part 26 is provided at a position corresponding to the protrusion 34 and the locking hole 33d. Also, the counterpart engaging part 26 is formed so as to be able to press the ascending inclined portion 34a (see FIG. 10) of the lock arm 33 in the downward direction Z2 to elastically deform the lock arm 33 in the downward direction Z2 while the connector housing 30 is being fitted to the counterpart housing 21. Also, as shown in FIG. 10, once the counterpart engaging part 26 has moved over the ascending inclined portion 34a to reach the locking hole 33d as a result of the connector housing 30 being completely fitted to the counterpart housing 21, the lock arm 33 that has been elastically deformed in the downward direction Z2 returns to the original position in the upward direction Z1. Then, the counterpart engaging part 26 is fitted into the locking hole 33d, and presses the action protrusion 53a in the downward direction Z2 to elastically deform the action piece 53 in the downward direction Z2. Consequently, the action protrusion 53a is not engaged with the protrusion-rear end face 34b, and the connector position assurance member 50 is allowed to move in the full locking direction X1, and thus is allowed to move from the partial locking position K1 (FIG. 10) toward the full locking position K2 (see FIG. 11). That is, the action protrusion 53a is allowed to move in the downward direction Z2 relative to the protrusion 34. As shown in FIGS. 9 and 10, in a state in which the connector housing 30 is fitted to the counterpart housing 21, the protrusion-rear end face 34b is opposed to the counterpart engaging part 26 in the fitting direction X1.

As shown in FIG. 11, once the connector position assurance member 50 has been moved to the full locking position K2, the action piece 53, including the action protrusion 53a, is disposed in the downward direction Z2 relative to the lock arm 33, thereby preventing the lock arm 33 from being flexed in the downward direction Z2. Note that when the connector position assurance member 50 is moved from the partial locking position K1 to the full locking position K2, the mounting projecting portions 52a (see FIG. 7) ride over the second projecting portions 37d of the pair of side walls 37 as a result of the pair of mounting pieces 52 being elastically deformed. Since the mounting piece 52 includes the inclined portions 52b, and the second projecting portions 37d include the inclined portions 37e, the mounting projecting portions 52a can easily ride over the second projecting portions 37d of the side walls 37. This prevents the counterpart engaging part 26 from deviating from a state of being opposed to the protrusion-rear end face 34b, and hence a state of being fitted into the locking hole 33d, and thus separation of the connector housing 30 from the counterpart housing 21 is prevented.

Here, how the connector housing 30 is being fitted to the counterpart connector 20 will be described in further detail. As shown in FIG. 12, an apex 34c, which constitutes a corner of the protrusion 34 and an upper end of the protrusion-rear end face 34b, of the protrusion 34 moves so as to rotate mainly about the base end portion 33a (see FIGS. 2 and 8) of the lock arm 33 as the lock arm 33 is flexed. In FIG. 12, a movement trajectory T of the apex 34c of the protrusion 34 is illustrated by the dashed double-dotted line. More specifically, when the lock arm 33 is flexed in the downward direction Z2 as a result of the protrusion 34 of the lock arm 33 being depressed by a lower surface of the counterpart engaging part 26, the apex 34c of the protrusion 34 also moves in the fitting-opposite direction X2 while moving in the downward direction Z2. The movement trajectory T is not limited to an arc of a perfect circle having the base end portion 33a as a center point, and also reflects the movement of the apex 34c of the protrusion 34 due to the deformation of the lock arm 33 itself.

When the counterpart engaging part 26 has passed over the apex 34c of the protrusion 34 as a result of the connector housing 30 being further moved in the fitting direction X1 relative to the counterpart connector 20, the lock arm 33 returns to the original position in the upward direction Z1. More specifically, the elastic force of the lock arm 33 causes the apex 34c of the protrusion 34 to be also moved in the fitting direction X1 while being moved in the upward direction Z1. The trajectory at this time is the same as the above-described movement trajectory T, and the apex 34c of the protrusion 34 returns to the original position.

Here, the protrusion 34 includes the protruding portions 35 protruding from the protrusion-rear end face 34b in the fitting-opposite direction X2. The protruding portions 35 each include a protruding portion-rear end face 35a that is opposed to the counterpart engaging part 26 in the fitting direction X1 in a state in which the connector housing 30 is fitted to the counterpart housing 21. The protruding portions 35 are provided within the range of the movement trajectory T of the apex 34c of the protrusion 34. Note that “being within the range” as mentioned here means being within the range on the side of the movement trajectory T of the apex 34c of the protrusion 34 where the protrusion 34 is present. More specifically, apexes 35b, which constitutes corners of the protruding portions 35 and upper ends of the protruding portion-rear end faces 35a, of the protruding portions 35 are located within the range of the movement trajectory T of the apex 34c of the protrusion 34. In the present embodiment, the apexes 35b of the protruding portions 35 are located on the movement trajectory T of the apex 34c of the protrusion 34.

Each of the protruding portion-rear end faces 35a is shaped such that a component of the force received from the counterpart engaging part 26 does not act in the downward direction Z2. More specifically, the protruding portion-rear end face 35a has a shape that prevents the lock arm 33 from being flexed in the downward direction Z2 by the force received from the counterpart engaging part 26 when a force acting in a direction in which the connector housing 30 is separated from the counterpart housing 21, or in other words, in the fitting-opposite direction X2 is applied to the connector housing 30. The protruding portion-rear end face 35a according to the present embodiment has a planar shape that is orthogonal to the first axis X.

As shown in FIG. 3, in a state in which the connector housing 30 is fitted to the counterpart housing 21, the counterpart terminals 24 serving as male terminals are inserted into the corresponding terminals 41 serving as female terminals, whereby the counterpart terminals 24 and the corresponding terminals 41 are electrically connected to each other. In a state in which the connector housing 30 is fitted to the counterpart housing 21, the dielectric-opposed surface 42d is opposed to the counterpart opposed surface 23b.

### Operations of the Present Embodiment

The operations of the present embodiment will be described below.

The operations of the connector 10 configured in the above-described manner will now be described.

When the connector housing 30 is moved relative to the counterpart housing 21 in the fitting direction X1 extending along the first axis X, the connector housing 30 is fitted to the counterpart housing 21, and the counterpart engaging part 26 is fitted to the locking hole 33d. Thus, the terminal 41 is connected to the counterpart terminal 24, and separation of the connector housing 30 from the counterpart connector 20 is prevented. Furthermore, when the connector position assurance member 50 is moved to the full locking position K2, the lock arm 33 is prevented from being flexed in the downward direction Z2, thereby strongly preventing separation of the connector housing 30 from the counterpart housing 21.

### Effects of the Present Embodiment

Next, the effects of the present embodiment will be described.

(1) The protrusion 34 of the lock arm 33 includes a protrusion-rear end face 34b that is opposed to the counterpart engaging part 26 in the fitting direction X1 in a state in which the connector housing 30 is fitted to the counterpart housing 21. Accordingly, separation of the connector housing 30 from the counterpart housing 21 is prevented. Also, the protrusion 34 includes protruding portions 35 protruding in the fitting-opposite direction X2 from the protrusion-rear end face 34b, and the protruding portions 35 each include a protruding portion-rear end face 35a that is opposed to the counterpart engaging part 26 in the fitting direction X1 in a state in which the connector housing 30 is fitted to the counterpart housing 21. Accordingly, the clearance can be smaller as compared with that of a configuration that does not include the protruding portions 35. That is, the rattling between the counterpart housing 21 and the connector housing 30 in the first axis X can be reduced as compared with a configuration that does not include the protruding portions 35. The protruding portions 35 are disposed within the range of the movement trajectory T of the apex 34c of the protrusion 34 during flexing of the lock arm 33. Accordingly, the protruding portions 35 will not collide with the counterpart engaging part 26 when the lock arm 33 that has been flexed in the downward direction Z2 during fitting of the connector housing 30 to the counterpart housing 21 returns to the original shape. Also, the protruding portion-rear end faces 35a are shaped such that a component of the force received from the counterpart engaging part 26 does not act in the downward direction Z2. Accordingly, for example, when a force acting in a direction in which the counterpart housing 21 and the connector housing 30 are separated from each other is applied, the lock arm 33 will not be flexed in the downward direction Z2. Thus, separation of the connector housing 30 from the counterpart housing 21 is prevented.

(2) Since the protruding portion-rear end face 35a has a planar shape that is orthogonal to the first axis X, it is possible, with a simple shape, to prevent a component of the force received from the counterpart engaging part 26 from acting in the downward direction Z2.

(3) Since the apexes 35b of the protruding portions 35 are located on the movement trajectory T, it is possible to minimize the clearance for the height of the protruding portion-rear end faces 35a. For example, as the apexes 35b of the protruding portions 35 move in the upward direction Z1 on the movement trajectory T of the apex 34c of the protrusion 34, the height of the protruding portion-rear end faces 35a increases and so does the clearance. In contrast, as the apexes 35b of the protruding portions 35 move in the downward direction Z2 on the movement trajectory T of the apex 34c of the protrusion 34, the height of the protruding portion-rear end faces 35a decreases and so does the clearance. That is, the apexes 35b of the protruding portions 35 can minimize the clearance for the height of the protruding portion-rear end faces 35a in a state in which the apexes 35b are located on the movement trajectory T of the apex 34c of the protrusion 34 included in the range of the movement trajectory T of the apex 34c of the protrusion 34. Thus, as a result of the apexes 35b of the protruding portions 35 being located on the movement trajectory T of the apex 34c of the protrusion 34, it is possible to minimize the rattling between the counterpart housing 21 and the connector housing 30 along the first axis X for the height of the protruding portion-rear end faces 35a. This makes it possible to minimize the rattling between the counterpart housing 21 and the connector housing 30 in the first axis X while, for example, the protruding portion-rear end face 35a has a height at which the counterpart engaging part 26 is unlikely to ride on the upper surface of the protruding portion 35.

(4) Since the terminals 41 are for use in high-speed communication, the communication performance of high-speed communication can be favorably maintained. That is, although the communication performance of the high-speed communication terminals 41 for high-speed communication deteriorates as the rattling between the counterpart housing 21 and the connector housing 30 in the first axis X increases, this deterioration can be kept small. Specifically, the dielectric-opposed surface 42d of the dielectric 42 covering the terminals 41 and the counterpart opposed surface 23b of the counterpart dielectric 23 covering the counterpart terminal 24 are opposed to each other, and a gap, which is an air layer, is formed therebetween. This gap is dependent on the relative position of the counterpart connector 20 and the connector housing 30. If the rattling between the counterpart housing 21 and the connector housing 30 in the first axis X increases, the gap between the dielectric-opposed surface 42d and the counterpart opposed surface 23b may become larger, and the increased gap results in deterioration of the communication performance for high-speed communication. Accordingly, the deterioration of the communication performance for high-speed communication can be kept small by reducing the rattling between the counterpart housing 21 and the connector housing 30 along the first axis X.

(5) Since the lock arm 33 includes a pair of arm parts 33b extending in the fitting-opposite direction X2 from opposite lateral sides of the protrusion 34, and an operation part 33c that couples the two arm parts 33b to each other, the protrusion 34 and the counterpart engaging part 26 can be disengaged from each other by depressing the operation part 33c. Accordingly, the connector housing 30 can be separated from the counterpart housing 21 by moving the connector housing 30 in the fitting-opposite direction X2 relative to the counterpart housing 21 while depressing the operation part 33c. Since the protruding portions 35 are respectively provided on the arm parts 33b, it is possible to reinforce the arm parts 33b on which the load tends to be focused during depression of the operation part 33c.

(6) Since the connector further includes the connector position assurance member 50 including an action protrusion 53a configured to prevent the lock arm 33 from being flexed in the downward direction Z2 in a state in which the action protrusion 53a is disposed in the downward direction Z2 relative to the protrusion 34, the engagement between the protrusion 34 and the counterpart engaging part 26 can be firmly maintained. Accordingly, separation of the connector housing 30 from the counterpart housing 21 is strongly prevented. Here, the protruding portions 35 are provided on the two arm parts 33b extending in the fitting-opposite direction X2 from opposite lateral sides of the protrusion 34, and therefore will not interfere with the action protrusion 53a exposed in the upward direction Z1 between the protrusion 34 and the operation part 33c.

### Modifications

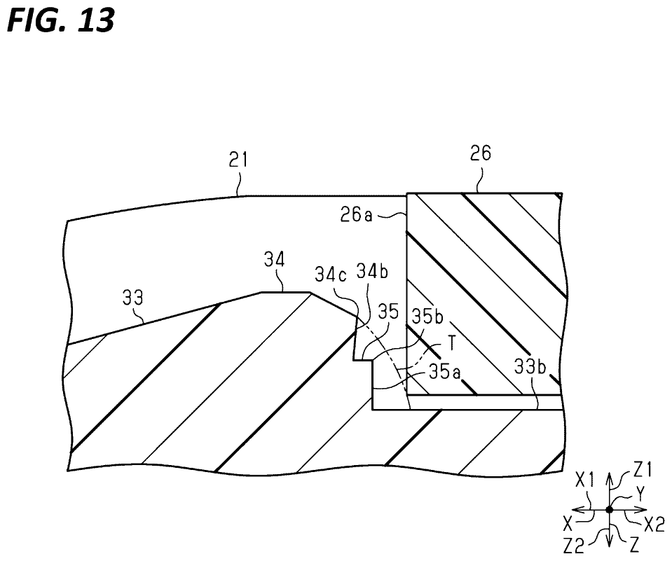

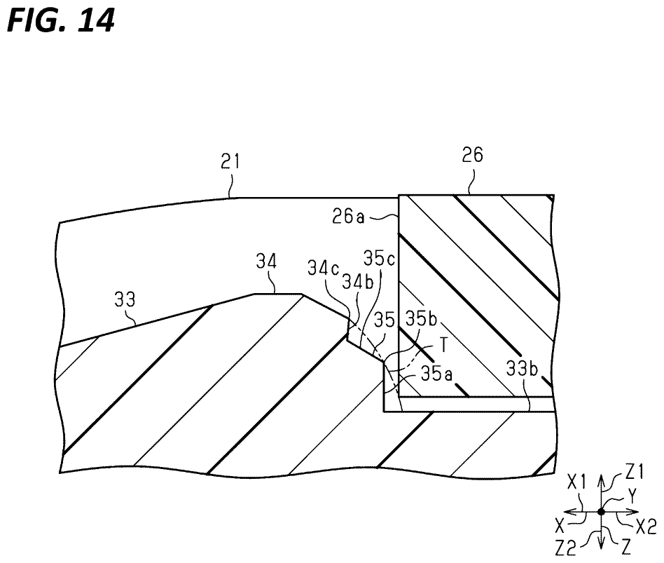

The above embodiment can be implemented with the following modifications. The above embodiment and the following modifications can be implemented in combination with each other as long as there are no technical discrepancies.
In the above embodiment, the apexes 35b of the protruding portions 35 are located on the movement trajectory T of the apex 34c of the protrusion 34. However, the present disclosure is not limited thereto. For example, as shown in FIG. 13, the apexes 35b may be located inward of the movement trajectory T of the apex 34c of the protrusion 34.
As shown in FIG. 14, it is possible to adopt configuration in which the upper surface of each of the protruding portions 35 includes an upper surface-inclined portion 35c that is inclined obliquely in the upward direction Z1 from the protruding portion-rear end face 35a in the fitting direction X1. This can prevent the counterpart engaging part 26 from being continuously riding on the upper surface of the protruding portion 35. That is, for example, even if the upper surface of the protruding portion 35 enters the lower surface side of the counterpart engaging part 26 as a result of the lock arm 33 being flexed in the downward direction Z2 due to vibrations or the like, the inclination of the upper surface-inclined portion 35c allows the protrusion 34 and the counterpart engaging part 26 to be guided to their original engaging position.
In the above embodiment, the protruding portion-rear end faces 35a have a planar shape that is orthogonal to the first axis X. However, the present disclosure is not limited thereto. The protruding portion-rear end faces 35a may have a planar shape that is not orthogonal to the first axis X. Alternatively, the protruding portion-rear end faces 35a need not have a planar shape as long as the protruding portion-rear end faces 35a are shaped such that a component of the force received from the counterpart engaging part 26 does not act in the downward direction Z2.

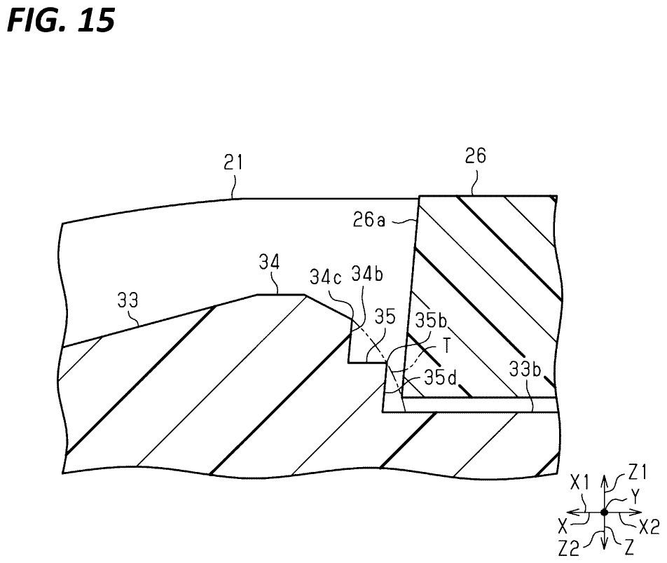

For example, a modification as shown in FIG. 15 may be made. The protruding portions 35 of this example each include a protruding portion-rear end face 35d, and the protruding portion-rear end face 35d has a planar shape that is inclined obliquely in the fitting-opposite direction X2 in the upward direction Z1.
In the above embodiment, the terminals 41 are for use in high-speed communication. However, the present disclosure is not limited thereto. The terminals 41 may be terminals for use in other types of communication. The terminals 41 are not limited to communication terminals, and may be power supply terminals, for example.
In the above embodiment, a configuration is adopted in which two protruding portions 35 are provided, and the protruding portions 35 are respectively provided on the two arm parts 33b. However, the present disclosure is not limited thereto. The protruding portions 35 need not be provided on the arm parts 33b. For example, it is possible to adopt a configuration that does not include any arm part 33b. In that case, the protruding portions 35 need only protrude in the fitting-opposite direction X2 from the protrusion-rear end face 34b.
In the above embodiment, a configuration including the connector position assurance member 50 is adopted. However, the present disclosure is not limited thereto.
In the above embodiment, a configuration is adopted in which the connector 10 includes one terminal unit 40, and a total of two terminals 41. However, the present disclosure is not limited thereto. The number of terminal units 40 and the number of terminals 41 that are included in the connector 10 may be changed.
In the above embodiment, a configuration is adopted in which the lock arm 33 includes two protruding portions 35. However, the present disclosure is not limited thereto. The number of protruding portions 35 included in the lock arm 33 may be changed.

From the foregoing, it will be appreciated that various exemplary embodiments of the present disclosure have been described herein for purposes of illustration, and that various modifications may be made without departing from the scope and spirit of the present disclosure. Accordingly, the various exemplary embodiments disclosed herein are not intended to be limiting, with the true scope and spirit being indicated by the following claims.

What is claimed is:

1. A connector comprising:
a connector housing configured to be fitted to a counterpart housing by being moved relative to the counterpart housing in a fitting direction extending along a first axis; and
a terminal accommodated inside the connector housing, wherein
the connector housing includes a lock arm extending in a fitting-opposite direction that is opposite to the fitting direction,
the lock arm includes a protrusion configured to flex the lock arm in a downward direction that is orthogonal to the fitting direction by being pressed by a counterpart engaging part of the counterpart housing while the connector housing is being fitted to the counterpart housing,
the protrusion includes a protrusion-rear end face opposed to the counterpart engaging part in the fitting direction in a state in which the connector housing is fitted to the counterpart housing, and at least one protruding portion protruding in the fitting-opposite direction from the protrusion-rear end face,
the protruding portion is disposed within a range of a movement trajectory of an apex of the protrusion during flexing of the lock arm, while including a protruding portion-rear end face opposed to the counterpart engaging part in the fitting direction in a state in which the connector housing is fitted to the counterpart housing, and
the protruding portion-rear end face is shaped such that a component of a force received from the counterpart engaging part does not act in the downward direction.

2. The connector according to claim 1, wherein
the protruding portion-rear end face has a planar shape that is orthogonal to the first axis.

3. The connector according to claim 1, wherein
an apex of the protruding portion is located on the movement trajectory.

4. The connector according to claim 1, wherein
the terminal is for use in high-speed communication.

5. The connector according to claim 1, wherein
the lock arm includes a pair of arm parts extending in the fitting-opposite direction from opposite lateral sides of the protrusion, and an operation part that couples the two arm parts to each other, and
the protruding portion is provided on each of the arm parts.

6. The connector according to claim 5, further comprising
a connector position assurance member including an action protrusion configured to: be exposed in an upward direction between the protrusion and the operation part in a state in which the connector housing is not fitted to the counterpart housing; be allowed to move in the downward direction relative to the protrusion in a state in which the connector housing is fitted to the counterpart housing; and prevent the lock arm from being flexed in the downward direction in a state in which the action protrusion is disposed in the downward direction relative to the protrusion.

7. The connector according to claim 1, wherein
an upper surface of the protruding portion includes an upper surface-inclined portion that is inclined obliquely upward from the protruding portion-rear end face in the fitting direction.
